(19) United States
(12) Patent Application Publication
(10) Pub. No.: US 2016/0332578 A1
(43) Pub. Date: Nov. 17, 2016

(54) SYSTEM AND METHOD FOR SETTING SIDE, REAR-VIEW, AND OTHER VEHICLE MIRRORS

(71) Applicant: Mark D. Wieczorek, San Diego, CA (US)

(72) Inventor: Mark D. Wieczorek, San Diego, CA (US)

(21) Appl. No.: 14/811,326

(22) Filed: Jul. 28, 2015

Related U.S. Application Data
(60) Provisional application No. 62/160,684, filed on May 13, 2015.

(51) Int. Cl. B60R 1/08; B60R 1/12; G06K 9/00

(52) U.S. Cl. CPC B60R 1/081; G06K 9/00604; G06K 9/0061; G06K 9/00845; B60R 1/12; B60R 2001/1253

(57) ABSTRACT

Disclosed are systems and methods that provide for the automatic adjusting and/or optimization of vehicle mirrors. In general, a camera, either real or virtual, is located at an appropriate place, e.g., reasonably proximate to the driver's eyes or on the mirror itself The images received by the camera are then analyzed as the mirror is moved, and an optimized and/or adjusted mirror setting is determined. The optimized setting may be determined by minimizing the sum of the incremental changes of sampled points between successive images for a given incremental rotation angle. The optimized setting may also be determined by maximizing the area of a polygonal figure generated in part by converging lines that represent an adjacent lane.

### CROSS-REFERENCE TO RELATED APPLICATIONS

This application claims benefit of priority to U.S. Provisional Patent Application Ser. No. 62/160,684, entitled “system AND METHOD FOR SETTING SIDE, REAR-VIEW, AND OTHER VEHICLE MIRRORS”, filed May 13, 2015, owned by the owner of the present application and herein incorporated by reference in its entirety.

### FIELD OF THE INVENTION

The field of the invention relates to vehicle mirrors, and more particularly to adjusting vehicle mirrors to provide an optimized mirror setting.

### BACKGROUND OF THE INVENTION

Rear view mirrors for vehicles, including buses and automobiles, are typically set manually. That is, even if actuated via a servomotor, the same are set with the driver handling or operating the actuator, the driver receiving feedback by the view in the mirror.

While the same may be satisfactory in many ways, problems are inherent in such systems. For example, the view is entirely subjectively set. Older drivers, or those with poorer vision, may not set the mirrors properly so as to appropriately or optimally view objects behind and to the side of their vehicles. Drivers may simply be used to a particular view, without regard as to whether the same is the best view. Drivers may not be aware of what the best view might be. For example, many drivers orient side view mirrors so as to be able to see a portion of the side of their own vehicle. This tendency gives rise to the well-known “blind spot”, which could be entirely eliminated with more proficient or optimal mirror orientation.

In some cases a driver may program mirror and seat settings, such that when the driver enters the vehicle, or otherwise gives an indication that they wish to operate the vehicle (e.g., depression of a driver setting button on a key fob or button within the vehicle, or use of a particular key fob, where ‘use’ is defined as proximity to the vehicle or depression of a button on the particular key fob), the mirrors are altered to the programmed setting. However, such simply moves the mirrors to the settings programmed by the driver, without regard as to whether such settings are appropriate for the driver.

If the driver has no settings set, or is using a key fob of a different driver, or forgets which profile to use, the process of setting mirrors must once again be performed, which is a significant driver annoyance, especially if the driver is rushed.

Current automobiles and other vehicles are equipped with numerous and significant computer functionality, but same is not generally taken advantage of when setting side and rear view mirrors.

Certain efforts have been made at increasing or benefiting the optical view within vehicles, e.g., U.S. Pat. No. 8,200,397, and WO 2012/172492, but the same are primarily related to driver eye position determination rather than mirror adjustment.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY OF THE INVENTION

The disclosed systems and methods provide for the automatic adjusting and/or optimization of vehicle mirrors. In general, a camera, either real or virtual, is located at an appropriate place, e.g., reasonably proximate to the driver's eyes or on the mirror itself Other locations may be appropriate, as would be known by one of ordinary skill in the art. The images received by the camera are then analyzed as the mirror is moved, and an optimized and/or adjusted mirror setting is determined.

In one aspect, the invention is directed to a method of adjusting a vehicle mirror, comprising: receiving two or more images from a camera; analyzing the received images to determine an adjustment amount; and transmitting the adjustment amount, whereby the mirror is adjusted by the adjustment amount.

Implementations of the invention may include one or more of the following. The camera may be located near the location of a driver's eyes. The camera may be located near the mirror. The receiving, analyzing, and transmitting steps may be repeated until a calculated value is optimized. The analyzing step may further comprise the steps of: sampling points from the two or more images; and comparing the sampled points between the two or more images to determine the adjustment amount. The calculated value may be the sum of the incremental changes of the sampled points between two images for a given incremental rotation angle. The calculated value may be optimized when the sum is minimized. The analyzing step may further comprise the steps of: identifying converging lines in the two or more images; and calculating the area between the converging lines to determine the adjustment amount, wherein the calculated value is the calculated area. The calculated value may be optimized when the area is maximized. The calculated value may be optimized when the area is substantially centered in the mirror.

In a related aspect, the invention is directed towards a non-transitory computer-readable medium comprising instructions for causing a computer environment to perform the above method.

In another aspect, the invention is directed towards a system for optimizing the configuration of a vehicle mirror, comprising: a camera; an optimizing module, for analyzing a series of images received from the camera to determine an optimal configuration for the mirror; and a mirror adjustment module, for adjusting the mirror to the optimal configuration.

Implementations of the invention may include one or more of the following. The camera may be located near the location of a driver's eyes. The camera may be located near the mirror. The optimizing module may sample points from the series of images and compare the sampled points between the series of images to determine the optimal configuration. The optimizing module may calculate the sum of the incremental changes of the sampled points between two successive images for a given incremental rotation angle. The mirror configuration may be optimized when the sum is minimized. The optimizing module may identify converging lines in the two or more images and calculate the area between the converging lines to determine the optimal configuration. The mirror configuration may be optimized when the area is maximized. The mirror configuration may be optimized when the area is substantially centered in the mirror.

Any of the features of an embodiment of any of the aspects, including but not limited to any embodiments described here, is applicable to all other aspects and embodiments identified herein, including but not limited to any embodiments described here. Moreover, any of the features of an embodiment of the various aspects, including but not limited to any embodiments described here, is independently combinable, partly or wholly with other embodiments described herein in any way, e.g., one, two, or three or more embodiments may be combinable in whole or in part. Further, any of the features of an embodiment of the various aspects, including but not limited to any embodiments of any of the aspects referred to above, may be made optional to other aspects or embodiments. Any aspect or embodiment of a method can be performed by a system or apparatus of another aspect or embodiment, and any aspect or embodiment of a system or apparatus can be configured to perform a method of another aspect or embodiment, including but not limited to any embodiments described here.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

Like reference numerals denote like elements throughout.

FIG. 1A illustrates an exemplary driver seat, including headrest and a posited centerline.

FIG. 1B illustrates a mirror optimization technique according to an aspect of the present invention.

FIG. 2 illustrates an alternative mirror optimization technique according to an aspect of the present invention.

FIG. 3 illustrates a further mirror optimization technique according to an aspect of the present invention.

FIG. 4 further illustrates the mirror optimization technique according to an aspect of the present invention illustrated by FIG. 3.

FIG. 5 illustrates a method according to an aspect of the present invention.

FIG. 6 illustrates a system according to an aspect of the present invention.

FIG. 7 illustrates an example computing environment according to an aspect of the present invention.

### DETAILED DESCRIPTION

Systems and methods according to present principles may solve one or more of the above-noted problems in various implementations. While the term “driver” is often used, the same will refer to any such operator or indeed any operator responsible for mirror positioning.

Two variations in particular are described herein, but one of ordinary skill in the art will recognize other variations. Both generally accomplish the same goal but one has one or more extra steps involved. Each generally rely on the placement of a camera, physical or virtual, at or near the location of the driver's eyes, e.g., at a location between the driver's eyes. In some implementations, two cameras may be employed, simulating binocular vision. The cameras may be virtual cameras (described in greater detail below) or actual physical cameras. The camera(s) may preferably be located in the seat back, at or near the position of the driver's eyes. However, as the driver's eyes are typically located ahead of the seat, particularly when the seat is in a desirable position, the view from a seat-mounted camera may be computationally altered to represent or simulate instead the desired view from the driver's eyes, e.g., from a position a few inches ahead or in front of the actual camera. However, various mechanisms may be employed instead to move a camera or cameras into the desired location (i.e., that of the driver's eyes, instead of simulating the view from the same). Virtual cameras refer to those whose view may be determined computationally, including by a physical camera, but where the virtual camera is not in the same position as the physical camera. In other words, the camera is “virtualized” to a hypothetical position, the hypothetical position generally being the eyes of the driver.

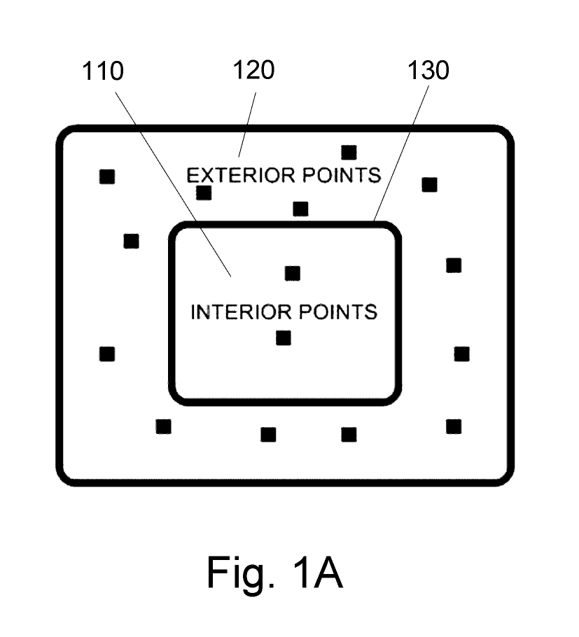

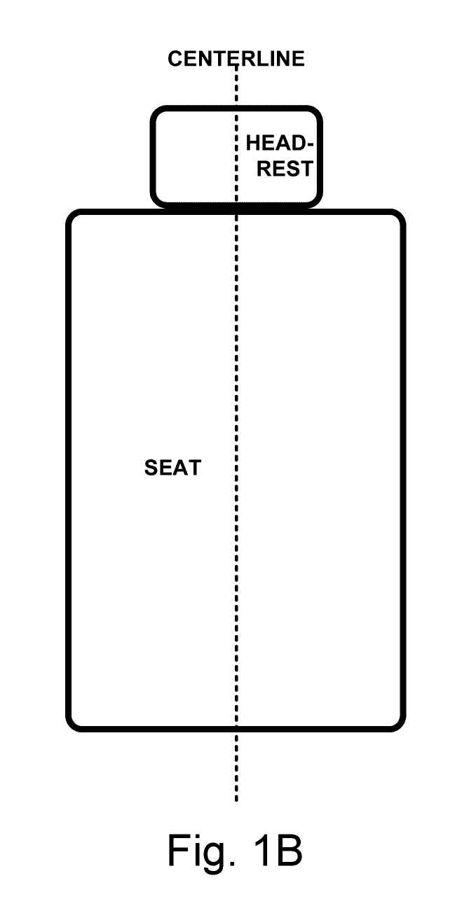

The camera(s) may also be located in the mirrors themselves, as described in greater detail below.

Where to position the camera(s), whether virtual or physical, may be set by the driver manually or may be estimated by the current systems and methods, using the seat position (which may include the pedal position) to estimate the height of the driver, and then by using an assumption about the position of the eyes relative to the driver's height. The driver may be assumed to sit in the center of the seat, and the eyes may thus be assumed to be on each side of the center line or on the center line, where just one exemplary eye is employed. If the above, the “centerline” is assumed to be that shown in FIG. 1A. In-vehicle cameras, if present, e.g., for security or safety, may allow the refinement of such assumptions by actually photographing portions of a driver's body and determining where the eyes are located, e.g., either with respect to the rest of the body, e.g., as a percentage of the torso length, body length, head size, or the like, or alternatively by noting the position of the eyes with respect to landmarks in the vehicle, e.g., seatback locations and/or orientations, the roof of the car, the top of the seatback, the location of the eyes relative to the steering wheel, the position of the steering wheel, or the like. Such cameras may in many cases be facing forward, but may then the employ visualized reflections from windows or mirrors, and by noting which reflection has, e.g., a steering wheel present, so as to determine which projection corresponds to a driver as opposed a passenger, the system may determine and localize one or more eyes on which to base the mirror optimization.

An adjustment knob or button may in some implementations be employed to allow for fine manual adjustments of mirror position.

The algorithm by which the mirror position and/or orientation, or both, is optimized and/or adjusted, will now be described. In one exemplary implementation according to present principles, the camera, physical or virtual, analyzes the image seen in the mirror as the mirror is panned along two axes, which are often perpendicular, but it is sufficient if the same are merely non-parallel. Panning along just one axis may be performed, but the same will often have results that are not as advantageous as where two axes are panned, particularly serially.

In more detail, the plane of the mirror may define axes such as a roll axis, a pitch axis, and a yaw axis. The pitch axis is generally horizontal, the yaw axis is generally vertical, and the roll axis generally emerges from the plane of the mirror. Once a camera position (e.g., driver eye position) is determined, the camera view from the determined position may be analyzed as the mirror is rotated about first one axis (either the pitch axis or the yaw axis) and then the other axis. The third axis, the roll axis, need not be analyzed in all implementations, generally, especially for square mirrors. For rectangular mirrors, the roll axis may be analyzed such that the long mirror edge is parallel to the roadway, such that the view of the road is largest, or encompasses most road detail, or by other optimization criteria. Of course, in some cases, roll axis variations are not enabled by the automobile.

The rotations may also be combined in a number of patterns. For example, the view may be optimized with respect to a first axis and then with respect to a second axis. Alternatively, a view may be partially optimized with respect to the first axis, followed by a partial optimization with respect to the second axis, followed by a refined optimization with respect to the first axis, followed by a refined optimization with respect to the second axis. Variations of such patterns will also be understood. Generally only a small rotation of the mirror need be performed, e.g., less than about 30° about each axis, from a coarsely-positioned starting orientation.

For each rotation the view is analyzed. Analysis of the view may involve analysis of points imaged in the mirror, and time analysis of the movement of such points as the mirror is rotated about the first or second axis, where such rotation occurs in a known manner, e.g., with a constant angular velocity or with a varying angular velocity where such functional definition of the variation is known.

FIG. 1 illustrates an example of a selection of sample points for sampling the view according to an embodiment of the present invention. Generally a sufficient number of points are sampled, where the sufficient number is defined as a number including contributions from interior points 110 and exterior points 120. Interior points 110 are within polygon 130 generally including the center of the mirror and occupying 10 to 90% of the area of the mirror, e.g., 25% to 75%, e.g., 40% to 60%. Exterior points 120 are those points exterior to polygon 130.

The movement of the points as the mirror is rotated may then be analyzed. This analysis can include consideration of the constant rotational angular velocity or the functional form of the rotational angular velocity if the same is nonconstant. At some point, the sum of the incremental movements of the points with respect to a particular incremental rotation angle will be a minimum with respect to the angular rotation about the corresponding axis. At this point, the orientation of the mirror may be considered optimal with respect to the corresponding axis of rotation. Put another way, as the mirror is serially (or in a parallel sense) rotated about the axis or axes shown, the position of the points will incrementally change, and the sum of these incremental changes with respect to a given incremental rotation angle will be for a given ΔΦ. Minimizing the sum, e.g., taking the derivative with respect to angle, gives a particular angle at which the sum of incremental movements of the points is minimized, and such may be determined to be the optimal orientation angle with respect to the given axis (about which Φ was measured). Performing this procedure for both axes then results in the preferred orientation.

In an alternative way of optimizing mirror orientation, a camera may shoot a directional radar beam or a laser beam and subsequently use interferometry to detect the longest response time or the orientation at which no response is received. Such a condition is generally present when the mirror is best for optimally configured, so long as a road is actually present.

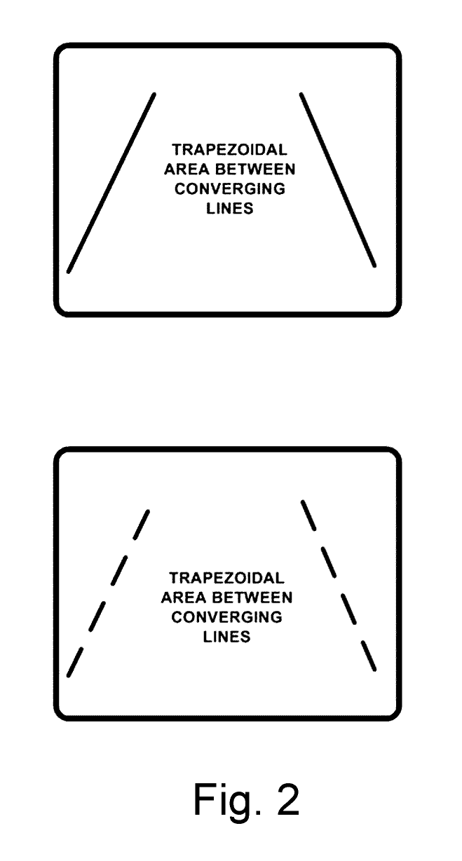

FIG. 2 illustrates another implementation, where the camera may look for evidence of an adjacent lane, particularly where such is embodied by a portion of a trapezoid, e.g., converging lines, and the system and method may attempt to maximize the area between the converging lines. At the point where the area is maximized, the mirror orientation may be considered as optimized. Alternatively, or in addition, the system may orient the mirror such that the area between the converging lines is substantially centered in the middle of the mirror.

In more detail, a polygon may be constructed using lane markers and the mirror may be oriented so as to maximize the size of the polygon, or rather to move the mirrors until the size of the polygon is maximized. This can be a continuing optimization as the vehicle drives down the road. Such an implementation may be particularly powerful if the driver and vehicle has a marked lane adjacent to them. If they do not, then one of the alternative implementations, e.g., using radar or a laser as described above, may be employed, e.g., using the same to determine where there is no return signal received or where the return signal takes the longest to be received.

In one implementation, an averaging filter may be employed to ensure that mirrors are not readjusted as the vehicle goes around curves.

Implementations of systems and methods according to present principles may take into consideration a driver's eye positions when the driver's head is turned. That is, mirrors may be optimized according to eye position, particularly where a driver's head is turned to follow the road. For example, if a road turns to the left, the driver's eyes, and mirror orientation, may be optimized automatically and temporarily for such eye positioning.

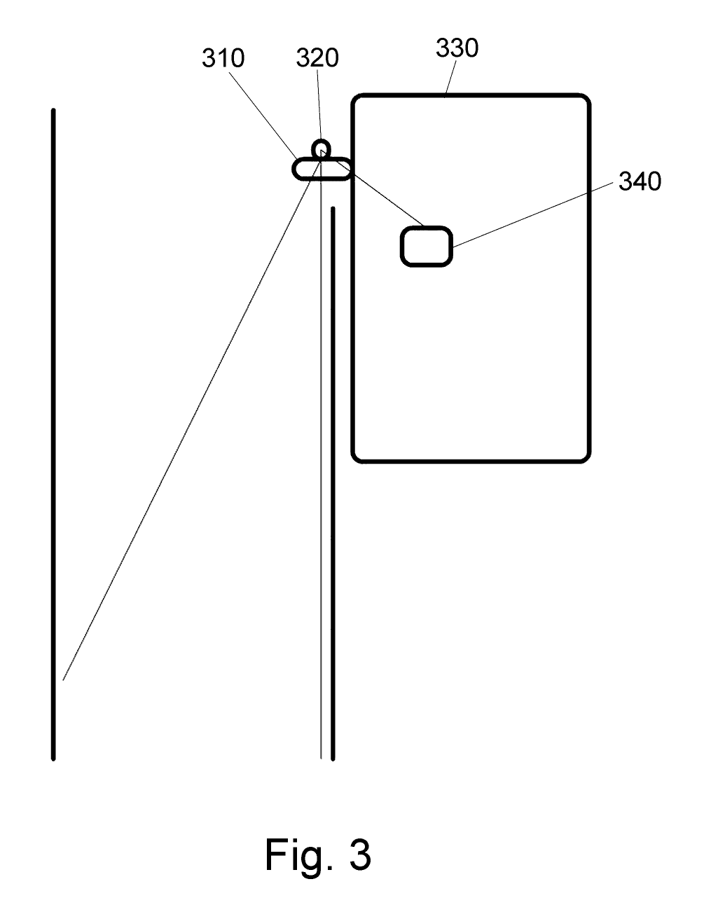

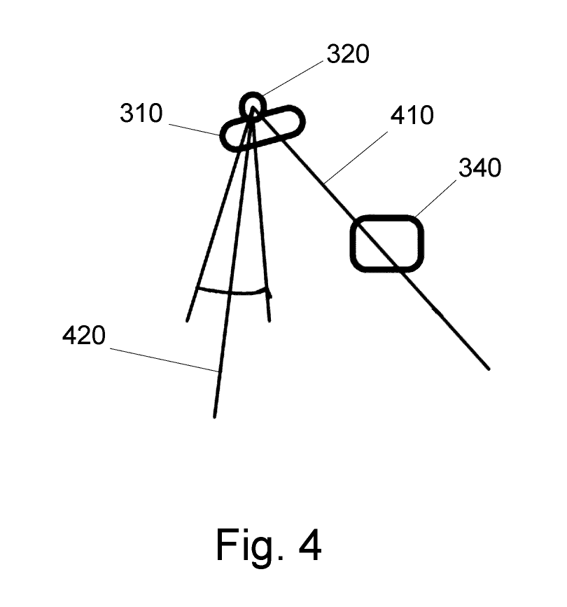

FIG. 3 illustrates an alternative embodiment where the camera is placed in the mirror itself and used for mirror orientation. Referring to FIG. 3, vehicle 330 has mirror 310, in this instance, a driver-side mirror. Camera 320 is located at or reasonably proximate to mirror 310. In this implementation, camera 320 may view directly the environmental features which allow for optimization of orientation, e.g., a trapezoidal (or other polygonal) appearance of a lane as delineated by lane markers 350. Optimization with camera 320 in mirror 310 would simply lead to mirror 310 facing the optimized position, e.g., the maximized trapezoidal area, and this situation may be undesired. However, camera 310 can also view the driver's eyes (the driver is indicated by numeral 340 in FIG. 3) using machine vision and/or optical recognition techniques, e.g., to distinguish the user's eyes from other aspects of the user, e.g., their nose. As illustrated by FIG. 4, a ray 410 may be drawn from the center of the user's eyes (between the eyes) to mirror 310, and reflected ray 420 computed. Reflected ray 420 may be computed in a manner such that ray 410 and reflected ray 420 are equidistant or equiangular about the normal to mirror 310. Mirror 310 may be oriented such that reflected ray 420 traverses down the center of the trapezoid delineated by the lane markers. This configuration may also be considered an optimized mirror orientation. Such a camera 320 may be structured and configured such that when not determining or optimizing mirror position, the same may be turned around, either in software or hardware, to face in a forward direction, for use as a dashboard camera.

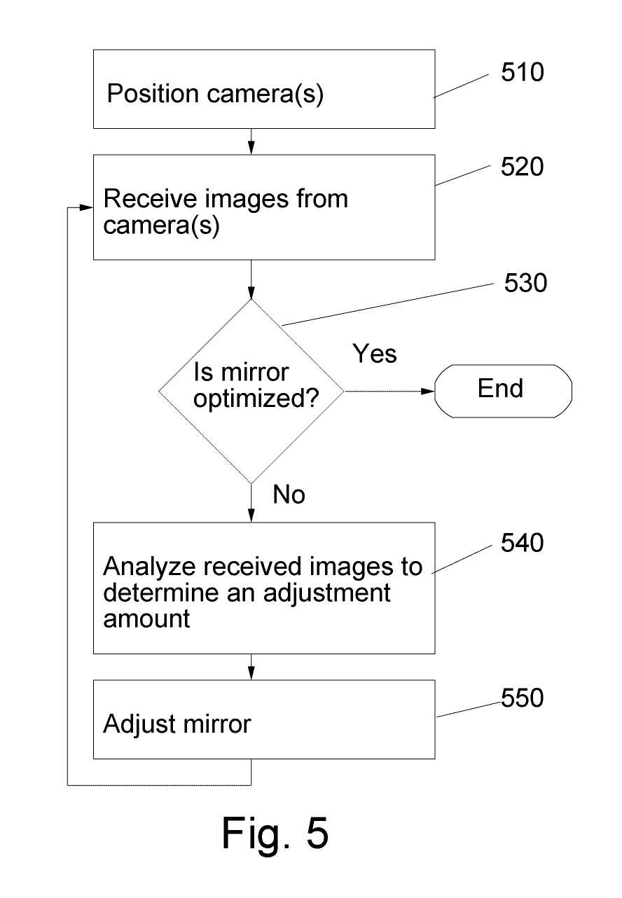

A method of one embodiment of the present invention is illustrated in FIG. 5. Starting at step 510, the cameras are placed at either the approximate location of the user's eyes or at the mirror, as described above. One of ordinary skill in the art will recognize other possible locations for the mirror.

At step 520, images are received from the camera. At step 530, the images are analyzed, in a manner as described above, to determine if the mirror is in an optimal configuration. For example, points on the images may be sampled and analyzed to find the sum of the incremental changes with respect to a given incremental rotation angle, as discussed above. If this sum is minimal or minimized, including just in a local fashion, then the mirror position may be optimal. Alternatively, if evidence of an adjacent lane is present, e.g., converging lines, the sum of the trapezoidal figure generated by these lines may be calculated. If this sum is a maximum, then the mirror position may be optimal because the mirror (and thus operator) are seeing a maximized amount of the lane. Other methods will be understood by those of ordinary skill in the art. If the mirror is determined to be in an optimized configuration, the method ends.

At step 540, an adjustment amount for the mirror is determined based on the received images. At step 550, the mirror is adjusted by the adjustment amount. The method then returns to step 520. Thus the rapidity with which the adjustment may be accomplished may allow mirror optimization to change temporarily even over very short time periods, e.g., while the user is going around a curve.

As described above, this method may be iterated upon over multiple axes. For example, the method may be performed to optimize the mirror configuration for the yaw axis, then the mirror orientation about the pitch axis may be optimized, or vice versa. Alternatively, the mirror orientation may be partly optimized about the yaw axis, then partly optimized for about the pitch axis, and this optimization for both axes may be iteratively repeated multiple times. One of ordinary skill in the art will recognize multiple methods for optimizing the mirror configuration.

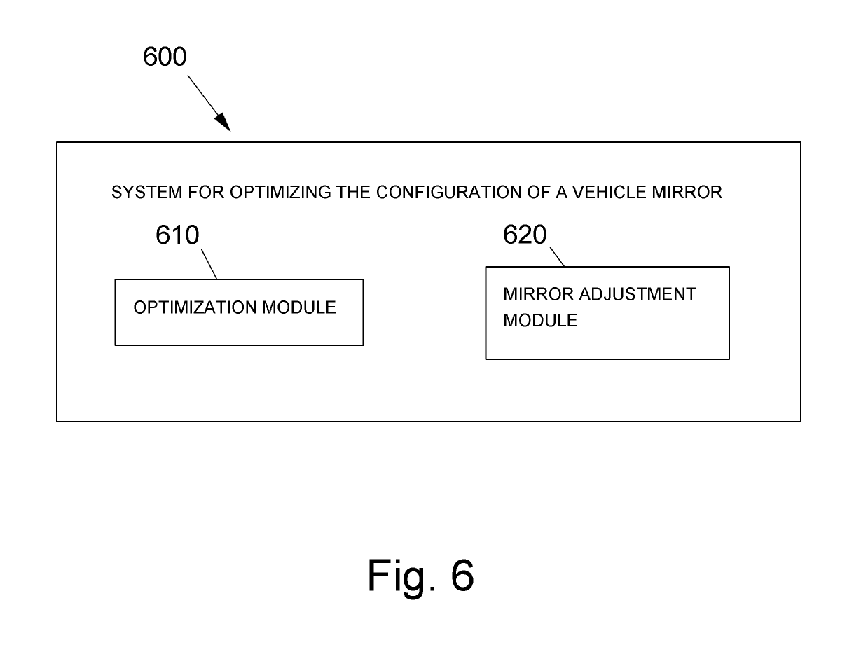

FIG. 6 illustrates an example system 600 for optimizing the configuration of a vehicle mirror. System 600 may include optimization module 610 which analyzes a series of images received from the camera to determine an optimal configuration for the mirror. System 600 may also include mirror adjustment module 620, for adjusting the mirror to the optimal configuration. These modules operate substantially as described above. The optimization module may optimize the mirror configuration using the point sampling method and/or the trapezoidal area method. The optimization may take place over multiple iterations with respect to multiple axes of rotation. Other related types and methods of optimization may also take place.

Variations of the disclosed systems and methods may include one or more of the following. Instead of an external, or a camera in or adjacent the mirror, the mirror may have a detector that automatically senses points on the mirror, which is again a type of internal camera, but one in which the entirety (or portion) of the mirror surface is used as a light sensor. The mirror positions may automatically be altered for non-normal conditions, including for driving during the night or driving during rain or snow conditions, or to accommodate bright headlights behind the subject vehicle. The mirrors for which position and orientation may be optimized include side mirrors, rear-view mirrors, and other mirrors on vehicles. The systems and methods according to present principles may further be applied to back up cameras and other cameras on vehicles. Systems and methods according to present principles may be applied to mirror position or orientation, or both. Systems and methods according to present principles may be applied to aircraft, buses, trains, boats, and other vehicles, particularly where the driver (or other operator) access to mirrors is prohibited or difficult.

Systems and methods according to present principles may be employed for use in orienting mirrors in videogames, movie animations, and so on. The same may be employed in orienting cameras that are facing the same direction as the mirrors which form the subject of the present case. Mirror rotation need not be over an entire span of movement, but just over a likely span of movement. Systems and methods may be implemented when a car has a new driver, or all the time, or if a driver desires to see what the system and method view as optimal.

As noted above, the camera may be arranged to face forward during normal driving. The same may be situated at an extremity of a vehicle to allow a view around curves, e.g., of road conditions, road directions, or oncoming traffic. The camera may be coupled to an alert system that may be configured to alert the driver to oncoming traffic, giving the operator precious fractions of a second extra response time, e.g., particularly on curvy mountain roads.

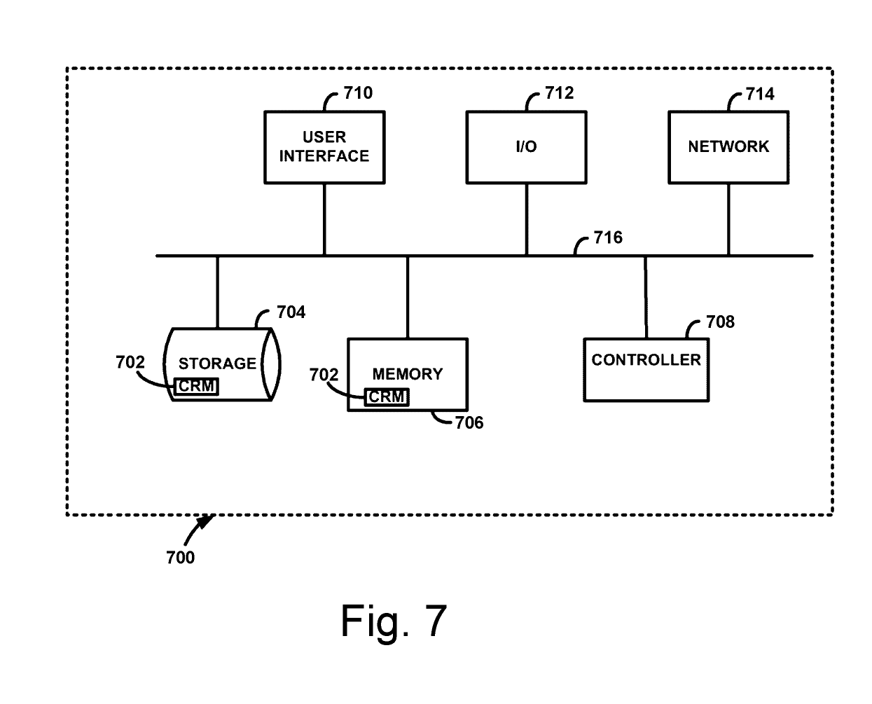

The systems and methods may be fully implemented in any number of computing devices. An exemplary computing device 700 on which the systems and methods may be implemented is shown in FIG. 7. Typically, instructions are laid out on computer readable media 702, generally non-transitory, and these instructions are sufficient to allow a processor in the computing device to implement the method of the invention. The computer readable medium may be a hard drive or solid state storage 704 having instructions that, when run, are loaded into random access memory 706. Inputs to the application, e.g., from the plurality of users or from any one user, may be by any number of appropriate controllers or computer input devices 708. For example, users may employ a keyboard, mouse, touchscreen, joystick, trackpad, other pointing device, or any other such computer input device to input data relevant to the calculations. Generally in systems and methods according to present principles, cameras and other visual inputs will be employed as entered data or inputs, and outputs will be to a servomotor controlling mirror orientation and position/location. Outputs may also include providing a set of instructions to a user that the user may follow to orient and/or position the mirror. The outputs may be delivered to a user by way of a video graphics card or integrated graphics chipset (not shown) coupled to a display, including user interface 710, that may be seen by a user. Computing device 700 may also have any number of additional I/O devices 712. Data may be entered by way of an inserted memory chip, hard drive, flash drives, flash memory, optical media, magnetic media, or any other type of file—storing medium. Additionally, a printer may be employed to output hard copies of the results. Given this teaching, any number of other tangible outputs will also be understood to be contemplated by the invention. For example, outputs may be stored on a memory chip, hard drive, flash drives, flash memory, optical media, magnetic media, or any other type of output. Network interface 714 may allow connections to a local network and/or an external network, including the internet. These components are interconnected by a common bus 716. It should also be noted that the invention may be implemented on any number of different types of computing devices, e.g., computers within vehicles, ASICs, personal computers, laptop computers, notebook computers, net book computers, handheld computers, personal digital assistants, mobile phones, smart phones, tablet computers, and also on devices specifically designed for these purpose. In one implementation, a user of a smart phone or wi-fi—connected device downloads a copy of the application to their device from a server using a wireless Internet connection. An appropriate authentication procedure and secure transaction process may provide for payment to be made to the seller. The application may download over the mobile connection, or over the WiFi or other wireless network connection. The application may then be run by the user. Such a networked system may provide a suitable computing environment for an implementation in which a plurality of users provide separate inputs to the system and method.

In some implementations, a smart phone or other mobile computer is coupled to a vehicle, such as via an OBD (onboard diagnostics) port. A Bluetooth connected camera (or a camera connected in another fashion to the computing environment) may be situated at the position of the driver's eyes to allow mirror orientation completely separately from the vehicle computer (although the vehicle computer may still send signals to cause mirror orientation to change according to the detected optimization). In this case, the OBD should be able to alter mirror positions or the same can also be done manually. Alternatively, the functionality as enabled by a separate connected camera may be coupled to the car computer to provide equivalent functionality.

1. A method of adjusting a vehicle mirror, comprising:
a. receiving two or more images from a camera;
b. analyzing the received images to determine an adjustment amount; and
c. transmitting the adjustment amount, whereby the mirror is adjusted by the adjustment amount.

2. The method of claim 1, wherein the camera is located near the location of a driver's eyes.

3. The method of claim 1, wherein the camera is located near the mirror.

4. The method of claim 1, further comprising the steps of:
a. repeating the receiving, analyzing, and transmitting steps until a calculated value is optimized.

5. The method of claim 4, wherein the analyzing step further comprises the steps of:
a. sampling points from the two or more images; and
b. comparing the sampled points between the two or more images to determine the adjustment amount.

6. The method of claim 5, wherein the calculated value is the sum of the incremental changes of the sampled points between two images for a given incremental rotation angle.

7. The method of claim 6, wherein the calculated value is optimized when the sum is minimized.

8. The method of claim 4, wherein the analyzing step further comprises the steps of:
a. identifying converging lines in the two or more images; and
b. calculating the area between the converging lines to determine the adjustment amount, wherein the calculated value is the calculated area.

9. The method of claim 8, wherein the calculated value is optimized when the area is maximized.

10. The method of claim 8, wherein the calculated value is optimized when the area is substantially centered in the mirror.

11. A non-transitory computer-readable medium comprising instructions for causing a computer environment to perform the method of claim 1.

12. A system for optimizing the configuration of a vehicle mirror, comprising:
a. a camera; and
b. an optimizing module, for analyzing a series of images received from the camera to determine an optimal configuration for the mirror; and
c. a mirror adjustment module, for adjusting the mirror to the optimal configuration.

13. The system of claim 12, wherein the camera is located near the location of a driver's eyes.

14. The system of claim 12, wherein the camera is located near the mirror.

15. The system of claim 12, wherein the optimizing module samples points from the series of images and compares the sampled points between the series of images to determine the optimal configuration.

16. The system of claim 15, wherein the optimizing module calculates the sum of the incremental changes of the sampled points between two successive images for a given incremental rotation angle.

17. The system of claim 16, wherein the mirror configuration is optimized when the sum is minimized.

18. The system of claim 12, wherein the optimizing module identifies converging lines in the two or more images and calculates the area between the converging lines to determine the optimal configuration.

19. The system of claim 18, wherein the mirror configuration is optimized when the area is maximized.

20. The system of claim 18, wherein the mirror configuration is optimized when the area is substantially centered in the mirror.
